(19) United States
(12) Patent Application Publication
(10) Pub. No.: US 2004/0085067 A1
(43) Pub. Date: May 6, 2004

(54) Gradient coil system and method for manufacturing a gradient coil system

(76) Inventor: Stefan Stocker, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/631,597

(22) Filed: Jul. 31, 2003

(30) Foreign Application Priority Data
Jul. 31, 2002 (DE) 102 35 056.6

(51) Int. Cl. G01V 3/00

(52) U.S. Cl. 324/318; 324/309

(57) ABSTRACT

In a gradient coil system for a magnetic resonance apparatus and a method for manufacturing such a gradient coil system, a first winding is arranged on a first surface and a conductor arrangement is arranged on a second surface spaced from the first surface, a conductor end of the first winding, located in an inner region of the first surface, is bent toward the second surface, and the conductor end is electrically conductively connected to the conductor arrangement.

### BACKGROUND OF THE INVENTION

1. Field of the Invention

The present invention is directed to a gradient coil system and to a method for manufacturing a gradient coil system.

2. Description of the Prior Art

Magnetic resonance technology is a known technology for, among other things, acquiring images of the inside of the body of an examination subject. In a magnetic resonance apparatus, rapidly switched gradient fields that are generated by a gradient coil system are superimposed on a static basic magnetic field that is generated by a basic field magnet. The magnetic resonance apparatus also includes a radiofrequency system that emits radiofrequency signals into the examination subject for triggering magnetic resonance signals, and picks up the magnetic resonance signals that have been triggered, on the basis of which magnetic resonance images are produced.

For example, U.S. Pat. No. 6,144,204 discloses an actively shielded gradient coil system composed of two disks for a magnetic resonance apparatus having an imaging volume between the two disks. Electrical connections between sub-coils of the gradient coil system are produced per disk by interconnects of the sub-coils projecting beyond the disk edge in a finger-like or strip-like, manner and these are appropriately bent and welded to one another.

In an actively shielded gradient coil system essentially composed of two disks, it is also known for the gradient coil and the appertaining shielding coil to have a helical conductor structure per disk for generating a gradient field with a gradient perpendicular to the circular surface of the disks. Terminal points of the two coils located approximately in the disk middle of the disk are to be electrically conductively connected to one another through other disk-like regions of the gradient coil system, for example for cooling device, radiofrequency shielding devices and/or shim devices. To that end, a solder connector is first applied by soft soldering to one of the terminal points perpendicular to the circular surface when manufacturing the gradient coil system. Subsequently, the other disk-like regions and the coil with the further terminal point, which is likewise connected to the solder connector by means of soft soldering, are assembled, and this assembly is cast with epoxy resin for forming the disk.

### SUMMARY OF THE INVENTION

An object of the present invention is to provide an improved gradient coil system wherein an electrically conductive connection to be produced within the gradient coil system is arranged such that the production can be implemented with optimally little negative effect on mechanical and electrical properties of the gradient coil system.

This object is achieved in accordance with the invention in a gradient coil system for a magnetic resonance apparatus, and a method for manufacturing such a gradient coil system, wherein a first coil is arranged on a first surface and a conductor arrangement is arranged on a second surface spaced from the first surface, a conductor end of the first coil arranged in an inner region of the first surface is bent toward the second surface, and the bent conductor end is electrically conductively connected to the conductor arrangement.

The invention is based on the perception that, given the conventional procedure described above wherein solder connectors to be soft soldered are utilized at two terminal points, the first and the further solder locations, which are often arranged more deeply and inaccessibly in the gradient coil system, are in turn separate with the second soft soldering. A hard soldering involving a creation of even more heat is precluded because this would increase the risk of damage to insulating materials that are arranged in the immediate proximity even more than the soft soldering.

Due to the bending of the conductor end in the gradient coil system according to the invention, in contrast, the connection point is displaced into a region that is less critical in terms of exposure to heat, and only one connection need be produced. The conventional solder connectors, which are implemented as milled and expensive discrete parts, are eliminated since the end of the conductor is continued three-dimensionally. The assembly outlay is also reduced due to the elimination of at least one soldering step. Further, fewer problems arise involving solder splatters that occur during soldering and that can cause shorts.

### DESCRIPTION OF THE DRAWINGS

FIG. 1 is a perspective view of a magnetic resonance apparatus with a planar gradient coil system that has two disks separated from one another.

FIG. 2 is a perspective view of a first winding arranged in one of the disks in accordance with the invention.

FIG. 3 is a perspective view of a carrier plate with the first winding adhering thereto in accordance with the invention.

FIG. 4 is a longitudinal section through a press brake device in an initial position in accordance with the invention.

FIG. 5 shows the press device after bending of a conductor end of the first winding has ensued in accordance with the invention,

FIG. 6 is a perspective view of the first winding connected to second winding to form a coil in accordance with the invention.

### DESCRIPTION OF THE PREFERRED EMBODIMENTS

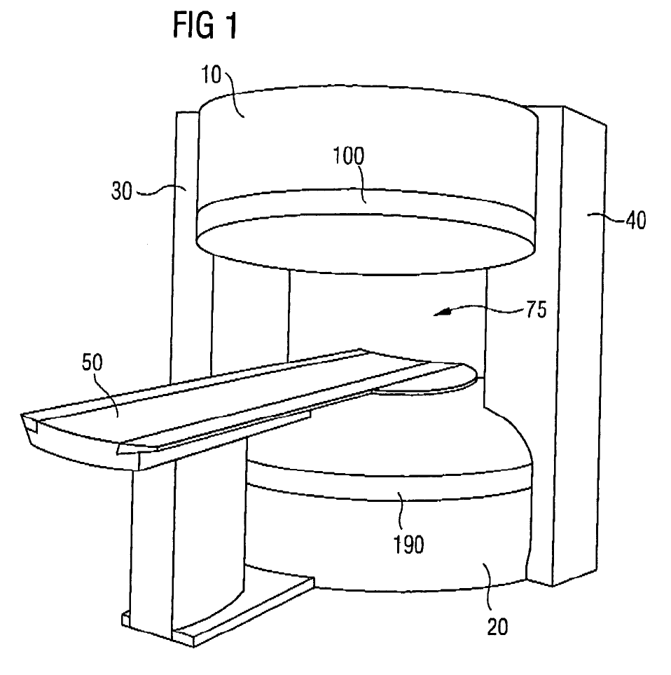

FIG. 1 shows a perspective view of a magnetic resonance apparatus wherein an upper and a lower, cylindrical base element 10 and 20 are connected to one another by two columns 30 and 40. An imaging volume 75 extends between the base elements 10 and 20. The magnetic resonance apparatus also has a support mechanism 50 with which a region to be imaged in an examination subject, placed on the support mechanism 50, can be positioned in the imaging volume 75. For generating a static basic magnetic field that is optimally uniform within the imaging volume 75, the magnetic resonance apparatus has a basic field magnet, the components of which are arranged at least in the base elements 10 and 20. For generating rapidly switched magnetic gradient fields that are optimally linear within the imaging volume 75, the magnetic resonance apparatus has an actively shielded, planar gradient coil system that is essentially composed of an upper disk 100 and a lower disk 190 cast with casting resin. The disks 100 and 190 each have a diameter of approximately 1 m and a thickness of a few centimeters.

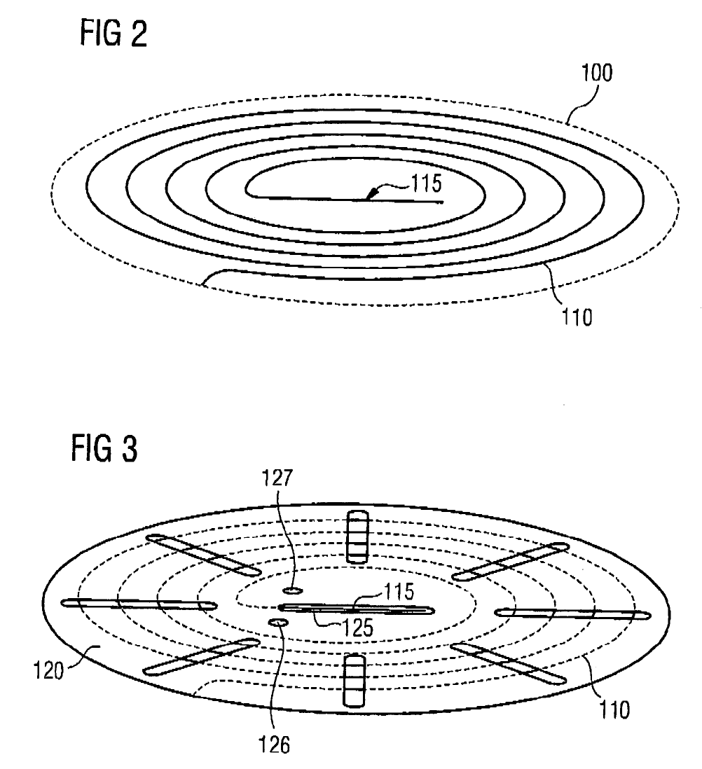

FIG. 2 shows a perspective view of a first winding 110 arranged in the upper disk 100 in an intermediate step in the manufacture of the upper disk 100. The edge of the winding 110 is indicated with a broken line. The first winding 110 is a component of a gradient coil of the gradient coil system for generating a gradient field with a gradient perpendicular to the circular surfaces of the disks 100 and 190. The first winding 110 is helically fashioned on a planar surface. To that end, the conductor of the first winding 110 is placed into channels of an assembly aid (not shown), the channels being milled corresponding to the desired conductor arrangement. A conductor end 115 is situated about in the middle of the disk 100. The end 115 is to be electrically conductively connected to a second winding 140 through further disk-like regions of the upper disk 100. The second winding 140 is allocated to a shielding coil belonging to the gradient coil.

An electrically insulating carrier plate 120 is placed onto the conductor of the first winding 110 lying in the assembly aid, the carrier plate 120 being connected to the conductor by a gluing process under elevated pressure and temperature conditions. The carrier plate 120 can be subsequently removed with the conductor of the assembly aid adhering thereto. Among other things, the carrier plate 120 has a recess 120 that enables an unimpeded access to the conductor end 115, at least from above and below. FIG. 3 shows a perspective view of the carrier plate 120 with the first winding 110 adhering to the underside of the carrier plate 120. The sections of the conductor of the first winding 110 covered by the carrier plate 120 are shown with broken lines.

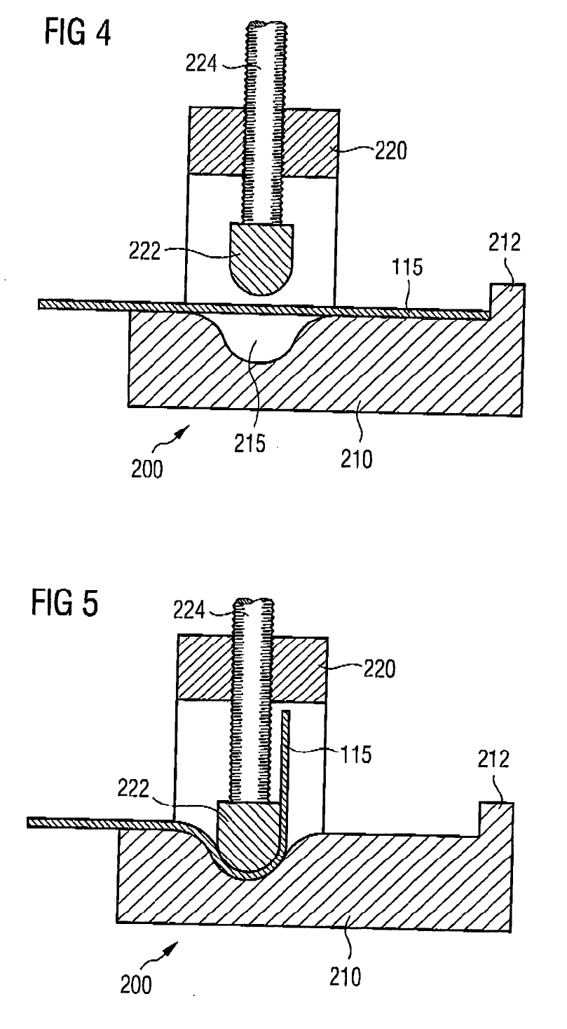

For producing the electrical connection between the two windings 110 and 140, the conductor end 115 is to be bent such that the conductor end 115 is directed perpendicularly to the carrier plate surface upward toward the second winding 140. To that end, a press device 200 (shown in greater detail in FIGS. 4 and 5) is temporarily mounted close to the middle of the carrier plate 120. A base swage element 210 of the press device 200 is arranged under the carrier plate 120 and under the conductor end 115, the plate 210 being screwed to a guide element 220 of the press device 200, arranged on top on the carrier plate 120 and over the conductor end 115, with bolts in two bores 126 and 127 introduced in the carrier plate 120. The exactly registered bores 126 and 127 in the carrier plate 120 result in the press device 200 being compelled into the correct position for the desired bending of the conductor end 115.

FIG. 4 shows a longitudinal section through the mounted press device 200 in an initial position with the conductor end 115 that has not yet been bent. The conductor end 115 is thereby placed on the swage base element 210 in a depression 215. In addition to the bores 126 and 127 in the carrier plate 120, a detent 212 of the swage base element 210 assures a correct positioning of the press device 200 for the desired bending. The press device 200 also has a die 222 that can be pressed into the depression 215 by a threaded rod 224 rotatably seated in the guide element 220 for bending the conductor end 115. The die 222 is lowered into the depression 215 by an appropriate rotation of the threaded rod 224, so that the conductor end 115 is bent perpendicularly to the carrier plate surface. FIG. 5 shows the press brake device 200 after the bending process has ensued.

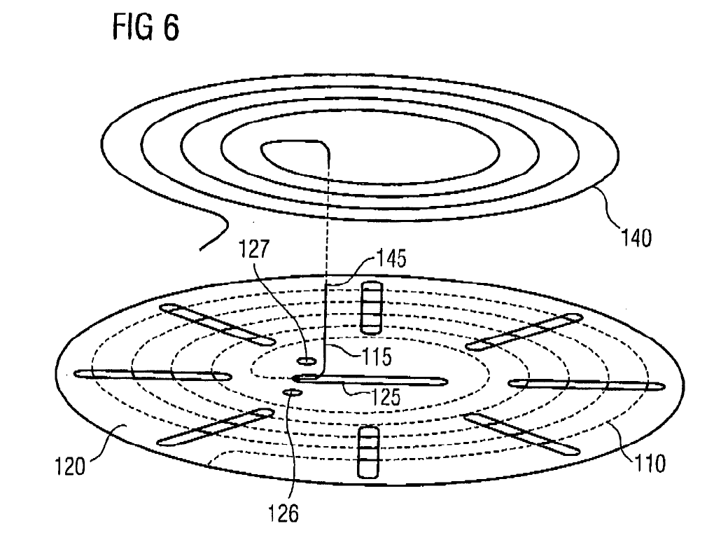

After the conductor end 115, as described above, has been bent, the press device 200 is removed and further disk-like regions of the upper disk 100 containing cooling devices and/or shim devices and the second winding 140 as well are constructed on the carrier plate 120. The upwardly bent conductor end 115 of the first winding 110 is thereby electrically conductively connected to a conductor end 145 of the second winding 140 by soldering or welding. This assembly shown in perspective view in FIG. 6, wherein the two windings 110 and 140 are shown at a greater distance from one another in the fashion of an exploded view, and regions between the windings 110 and 140 and containing cooling devices and/or shim devices are not shown for clarity. Following a further attachment of further windings for further gradient coils and appertaining shielding coils, the entire structure is cast with casting resin for forming the upper disk 100. The procedure when manufacturing the lower disk 190 of the planar gradient coil system is analogous.

That described above can also be advantageously employed for windings of hollow-cylindrical gradient coil systems.

Although modifications and changes may be suggested by those skilled in the art, it is the intention of the inventor to embody within the patent warranted hereon all changes and modifications as reasonably and properly come within the scope of his contribution to the art.

I claim as my invention:

1. A gradient coil system for a magnetic resonance apparatus comprising:
a winding disposed on a first surface and a conductor arrangement disposed on a second surface spaced from said first surface;
said winding having a conductor and located in an inner region of the first surface that is bent toward the second surface; and
an electrically conductive connection of the conductor end and the conductor arrangement.

2 A gradient coil system as claimed in claim 1, wherein the conductor arrangement has a conductor end that is bent corresponding to the conductor end of the winding for mechanical and electrical connection to the conductor end of the winding.

3. A gradient coil system as claimed in claim 1, wherein the conductor arrangement is a second winding.

4. A gradient coil system as claimed in claim 1, wherein the first and second windings respectively form a gradient and shielding coil.

5. A gradient coil system as claimed in claim 1, wherein at least one of the first and second surfaces is planar.

6. A gradient coil system as claimed in claim 1, wherein the electrically conductive connection is selected from the group consisting of soldered connections and welded connections.

7. A gradient coil system as claimed in claim 1, wherein at least one winding and said conductor arrangement is a helical conductor.

8. A method for manufacturing a gradient coil system comprises the steps of:
arranging a conductor of a winding is arranged on a first surface in a prescribable shape;
arranging a conductor arrangement on a second surface spaced from the first surface;
bending a conductor end of the winding in an inner region of the first surface is toward the second surface; and
electrically connecting the conductor end of the winding to the conductor arrangement.

9. A method as claimed in claim 8, comprising placing the conductor of the winding in channels of an assembly aid for fashioning the prescribable shape.

10. A method as claimed in claim 8, comprising joining a carrier to the winding by gluing.

11. A method as claimed in claim 8, comprising bending said conductor end with a press device.

12. A method as claimed in claim 11, wherein the press device has a swage base element and a guide element guiding a die that are connected to one another at both sides of the conductor end, and bending said conductor end by guiding said die toward said swage base element with said conductor end therebetween.

13. A method as claimed in claim 12 comprising joining the winding to a carrier, having bores therein, by gluing, and positioning the press brake device relative to the winding by bolds proceeding through said bores, and which also hold the swage base element and the guide element to one another.
